(19) United States
(12) Patent Application Publication
(10) Pub. No.: US 2008/0320041 A1
(43) Pub. Date: Dec. 25, 2008

(54) ADDING VIRTUAL FEATURES VIA REAL WORLD ACCESSORIES

(75) Inventors: Jonathan R. Engelsma, Hudsonville, MI (US); Mathieu C. Hans, Hoffman Estates, IL (US); Venugopal Vasudevan, Palatine, IL (US); James C. Ferrans, Wheaton, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/766,446

(22) Filed: Jun. 21, 2007

(51) Int. Cl. G06F 17/30

(52) U.S. Cl. 707/104.1; 707/E17.005

(57) ABSTRACT

A method, apparatus, and electronic device for enhancing virtual features in devices are disclosed. A connection interface may pair the mobile telecommunications apparatus with a first accessory. A processor may execute a software program and add a virtual feature associated with the first accessory when the first accessory is present.

### FIELD OF THE INVENTION

The present invention relates to a method and system for enhancing gaming. The present invention further relates to adding virtual feature to a computer program.

### INTRODUCTION

Modern mobile telecommunications devices, such as cellular telephones, have reached a degree of technical sophistication allowing these devices to execute a wide variety of software programs. One type of software program that has seen a great deal of growth in the mobile handset arena is gaming content. These mobile telecommunications devices may link together to create a vast interactive virtual universe or multiple virtual universes.

The capabilities of the mobile telecommunication devices may be improved or upgraded by adding accessories. For example, a Bluetooth® headset may be associated with a mobile telecommunication handset in order to free a user's hands. These accessories have become more common as more and more states begin banning the use of cellular phone without a headset while driving cars.

### SUMMARY OF THE INVENTION

A method, apparatus, and electronic device for enhancing virtual features in devices are disclosed. A connection interface may pair the mobile telecommunications apparatus with a first accessory. A processor may execute a software program and add a virtual feature associated with the first accessory when the first accessory is present.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates one embodiment of a system of computing devices using virtual features associated with real world objects.

FIG. 2 illustrates one embodiment of a gaming system with enhanced virtual features.

FIG. 3 illustrates one embodiment of a media presentation system with enhanced virtual features.

FIG. 4 illustrates one embodiment of a computing system capable of creating a virtual feature independent of a server.

FIG. 5 illustrates one embodiment of a computing system with accessories capable of self-tracking.

FIG. 6 illustrates one embodiment of a computing system transferring an accessory and virtual feature between computing devices.

FIG. 7 illustrates in a flowchart one embodiment of a method of associating an accessory with a virtual accessory.

FIG. 8 illustrates in a flowchart one embodiment of a method for using a virtual feature that acts as a coupon.

FIG. 9 illustrates a possible configuration of a computer system to act as a mobile system or location server to execute the present invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of computer, mobile device, or wireless communication device.

A method, mobile telecommunications apparatus, and electronic device for enhancing virtual features in devices are disclosed. A connection interface may pair the mobile telecommunications apparatus with a first accessory. A processor may execute a software program and add a virtual feature associated with the first accessory when the first accessory is present.

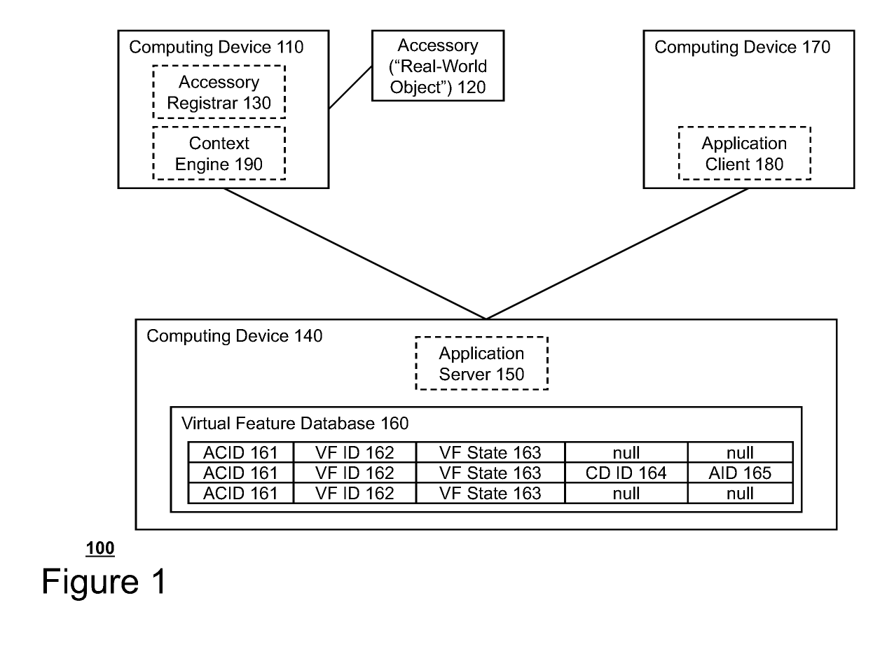

FIG. 1 illustrates one embodiment of a generic system 100 of computing devices 110 with enhanced virtual features. A computing device 110 may be paired with an accessory 120. The computing device 110 may be a mobile communications device, a handheld computer, a cellular telephone handset, or other devices capable of performing computation. The accessory 120 may be a piece of hardware with a unique identity associated with a computing device. The state of the accessory 120 may change, such as from a state of “associated” to “not associated” or vice versa. The accessory may be later integrated with the computing device. The accessory 120 may be a Bluetooth® headset, view screen, speakers, or other real world object that may connect to a computing device 110. The accessory 120 may be paired with the computing device 110 via a physical connection, wireless connection, optical connection, or other type of connection. The accessory 120 may be associated with one or more virtual features usable by the computing device.

The computing device 110 may invoke an accessory register program 130. The computing device 110 allows a user to interact with the accessory registrar program to select from a list of possible programs and virtual features in those programs. The programs may be games, media players, or other programs. The virtual feature may be a function, object, or other feature that is active in a virtual environment. The virtual features may be unrelated to the actual features of the real world object. Upon selection by the user, the accessory registrar 130 may connect to a second computing device 140 running an appropriate application server 150. The application server 150 on computing device 140 may be a huge server farm at an application hosting center, a single personal computer, a mobile device, or other computing devices.

The application server 150 may create a data record representing the new virtual feature and install it in the virtual feature database 160. Alternatively, the accessory manufacturer or another party may set up a trusted database of valid accessories that the application server 150 may interface with to avoid hackers. A virtual feature database 160 entry for a virtual feature not linked to a physical object may contain simply an application client identifier (ACID) 161, a virtual feature identifier (VFID) 162, and state information for a virtual feature (VF State or virtual feature state) 163. A virtual feature database 160 entry for virtual feature linked to a physical object may include a computing device identifier (CDID) 164 of the associated computing device 110 and an accessory identifier (AID) 165 of the accessory 120.

An application may be run on the computing device 110 paired with the accessory 120 or an associated computing device 170. During use of the application by an associated computing device 170, the application client 180 runs and communicates with the application server 150. The application server 150, when manipulating a virtual feature linked to an accessory 120, communicates with a context engine 190 to find the current benchmark context. The benchmark context may be the context of the accessory 120, the computing device 110, or some other object whose context is used as a benchmark to alter the state of the virtual feature. The context may be any physical or virtual data about an object that varies over time. The context engine 190 may adjust the state of the virtual feature as the benchmark context changes. This change in state is communicated to the virtual feature database 160, and is reflected in the VF state entry 163. The benchmark context may be the age of a benchmark device, the altitude of a benchmark device, the power level of a benchmark device, the distance between the accessory 120 and the computing device 110, or some other characteristic.

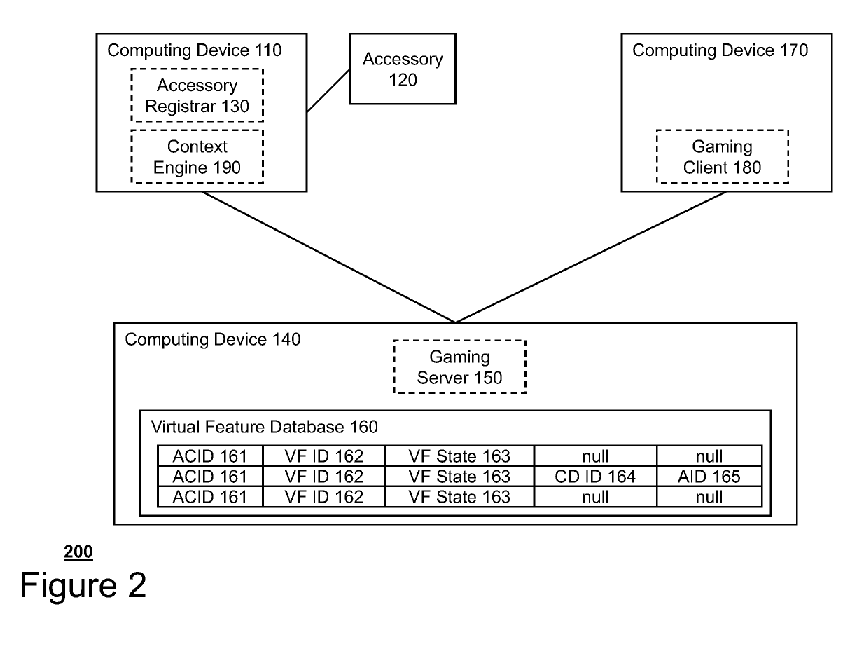

FIG. 2 illustrates one embodiment of a gaming system 200 with enhanced virtual features. The gaming system 200 may have the same structure as the generic system of FIG. 1. The virtual features may be objects usable by a player in a virtual game environment, such as a sword, a map, or other virtual items. The virtual feature may be a virtual function usable by a player in a virtual game environment, such as flight, teleportation, super-speed, and other functions.

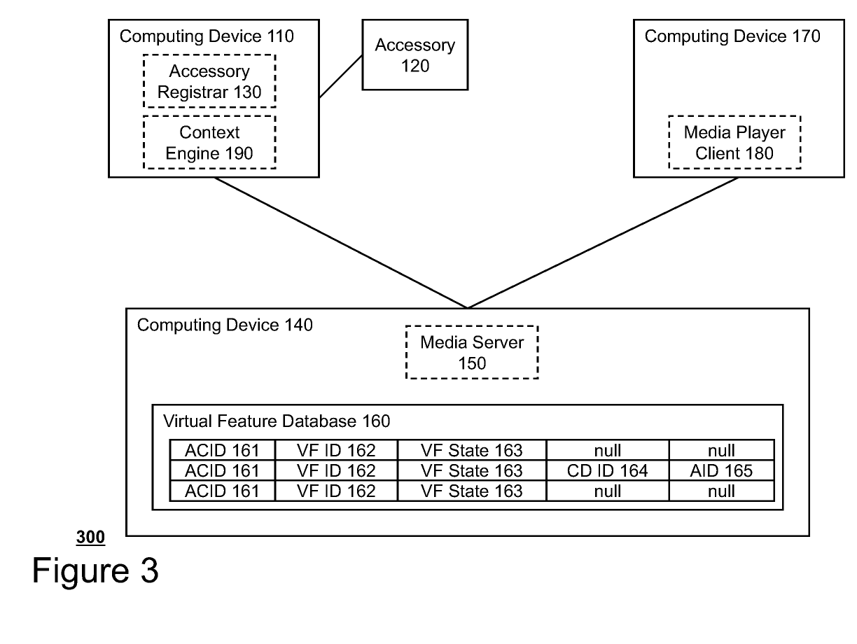

FIG. 3 illustrates one embodiment of a media presentation system 300 with enhanced virtual features. The media presentation system 300 may have the same structure as the generic system of FIG. 1. The virtual features may be an extra function of the media presentation application, such as extra speed controls on a video player, enhanced sound, enhance video features (such as a video zoom) or other extra functions.

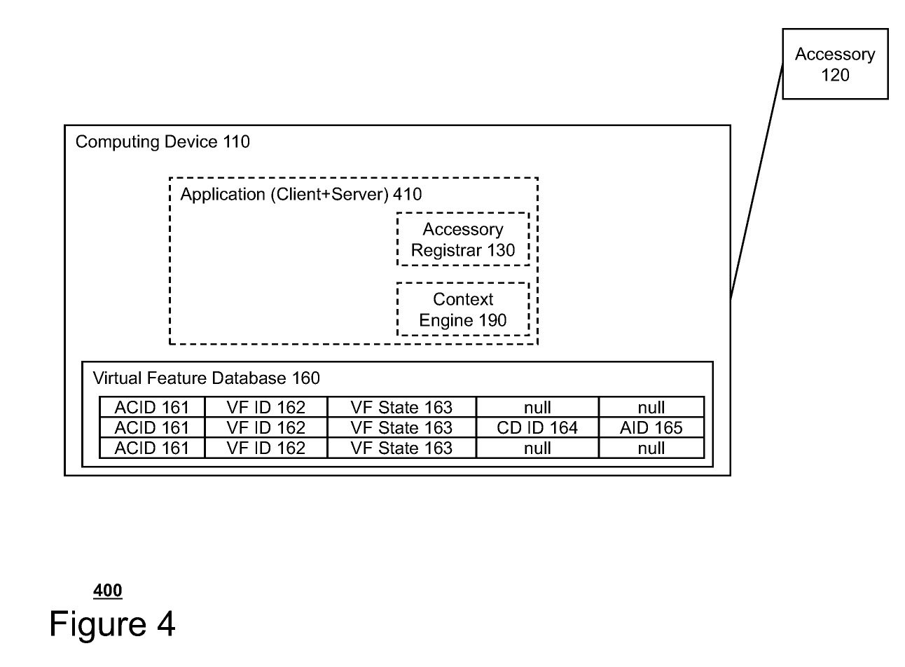

FIG. 4 illustrates one embodiment of a computing system 400 capable of creating a virtual environment independent of a server. The computing device 110 runs an independent application 410 combining both the client and server functions in creating the virtual environment. The independent application performs all of the functions of the application server 150. Additionally, the independent application 410 may execute an accessory registrar application 130 and a context engine 190. The independent application 410 may also administer the virtual feature database 160, which is stored on the computing device 1 10.

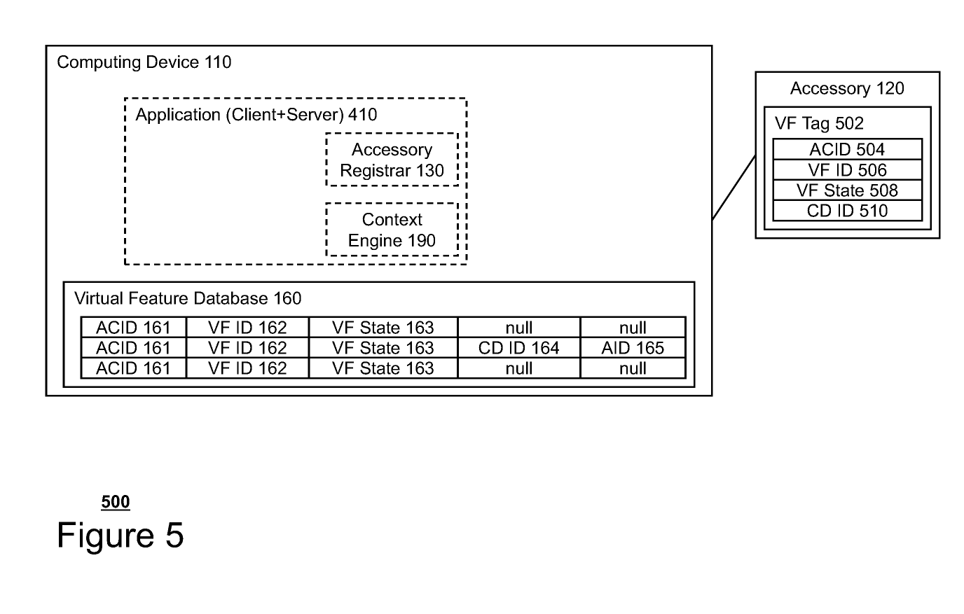

FIG. 5 illustrates one embodiment of a computing system 500 with accessories 120 capable of self-tracking. In this embodiment, each accessory 120 may contain a memory capable of storing one or more virtual feature (VF) tags 502. The memory may be any type of memory known in the art. The VF tag 502 may include the information stored in the virtual feature database (VFDB) entry for that accessory, such as an ACID 504, a VFID 506, a VF State 508, and a CDID 510. This information may be read by the computing device 110 when first paired with the accessory 120, and used to establish the virtual feature in the application client 410. As the benchmark context changes, the context engine 190 may calculate a new state for the virtual feature and update the VF State 510 as stored in the VF tag 502. The application client 410 may calculate a new state for the virtual feature based upon events in the virtual environment and update the VF State 510 as stored in the VF tag 502. The new states represent new characteristics for the virtual feature. For example, if the virtual feature is increased running speed in a virtual game environment, and the context of the accessory 120 changes so that the accessory is at a higher altitude, the state of the running speed may be changed so that the running speed is reduced. For an alternate example, if the virtual feature is finer playback speed control for a media player, and the context of the computing device 110 changes in that it ages, the granularity of the playback speed control may increase.

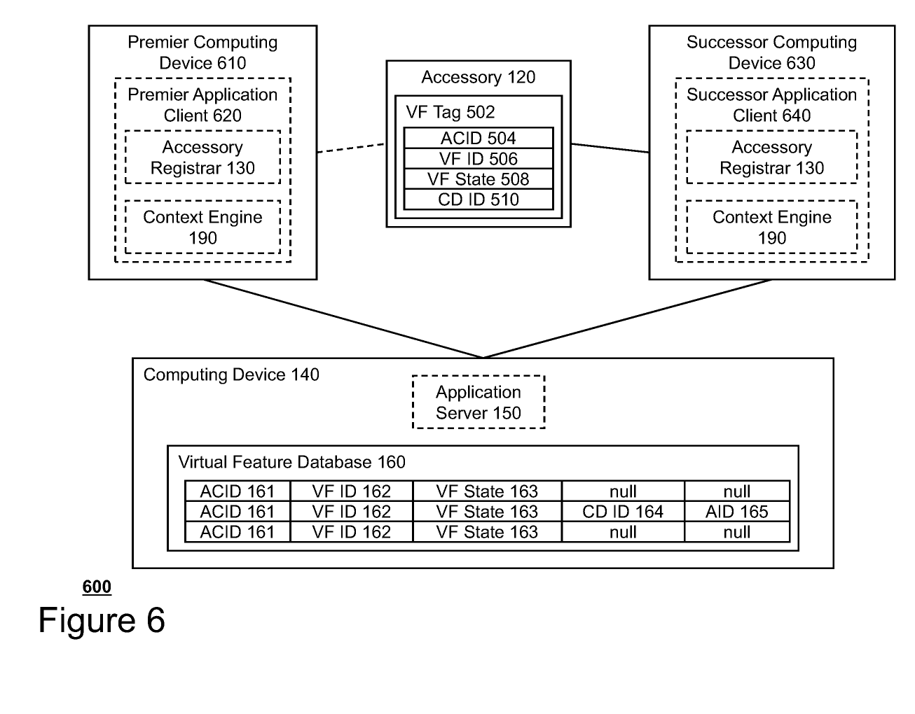

FIG. 6 illustrates one embodiment of a computing system 600 transferring an accessory 120 and virtual feature between computing devices. A premier computing device 610 may be running a premier application client 620. The premier computing device 610 may be paired with an accessory 120. The premier application client 620 may access the virtual feature database 160 or the VF tag 502 to determine the virtual feature associated with the premier application client 620 and that accessory 120. The state of the virtual feature may be changed as the context engine 190 determines a change in the benchmark context. The change in state may be tracked in the virtual feature database 160 or in the VF tag 502.

At some point, the accessory 120 may be transferred to a successor computing device 630, running a successor application client 640. The successor application client 640 may access the virtual feature database 160 or the VF tag 502 to determine the virtual feature associated with the successor application client 640 and that accessory 120. The virtual feature for the successor application client 640 may be different than the virtual feature for the premier application client 620, but the state may remain constant.

For example, the premier application client 620 may be a fantasy fighting game, and the virtual feature may be a sword. The sword becomes duller as the accessory 120 ages. The accessory 120 may be separated from the premier computing device 610, and then paired with the successor computing device 630. The successor application client 640 may be a spaceship battle game, and the virtual feature may be a set of photon torpedoes. The set of photon torpedoes may be depleted to reflect the state change that occurred in the previous incarnation.

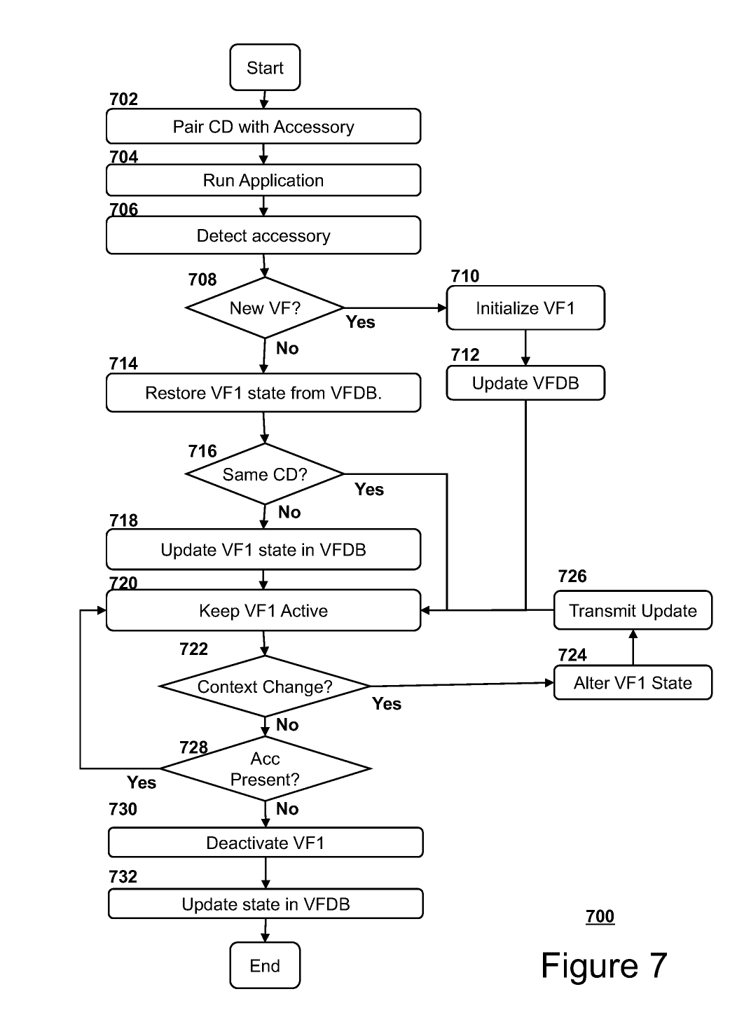

FIG. 7 illustrates in a flowchart one embodiment of a method 700 of associating an accessory 120 with a virtual accessory 140. The CD 110 may be paired with a first accessory 120 (Block 702). The CD 110 may then run an application (Block 704). The application on the CD 110 may then detect the presence of the accessory 120 (Block 706). If a virtual feature (VF) for this accessory 120 and application has not been previously instantiated (Block 708), then the application may initialize VF (Block 710). The application may then update the VF database (VFDB) 160 to reflect the new VF (Block 712). If a virtual feature (VF) for this accessory 120 and application has been previously instantiated (Block 708), then the application may restore the first virtual feature (VF1) state from the VFDB 160 (Block 714). If the same CD 110 is not being used (Block 716), the application updates the VF1 state in the VFDB 160 (Block 718). The application may then keep the VF1 active (Block 720).

If the context engine 190 of the application detects a context change (Block 722), the application may alter the state of the VF1 (Block 724). The application may then transmit to the VFDB 160, the VF tag 502, or other representation of the VF1 an update to the entry representing the state of VF1 (Block 726). If the accessory 120 is present to the application (i.e. the accessory is present and the application is running) (Block 728), the application may keep the VF1 active (Block 720). If the accessory 120 is not present to the application (Block 728), the application may deactivate VF1 (Block 730). The application may update the state in the VFDB 160, the VF tag 502, or other representation of the VF1 (Block 732).

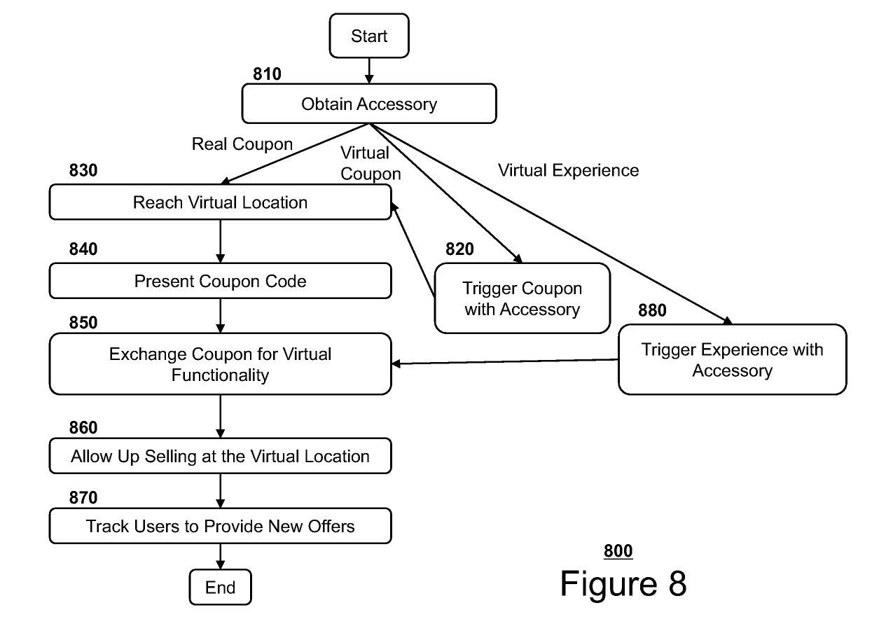

FIG. 8 illustrates in a flowchart one embodiment of a method 800 for using a virtual feature 140 that acts as a coupon. The computing device 110 may obtain an accessory 120 (Block 810). For a virtual coupon, the computing device 110 may trigger a coupon with the accessory 120 (Block 820). For virtual coupons or real coupons, the computing device 110 executes a program that allows a user to reach a virtual location (Block 830). The computing device 110 allows the user to present the coupon code to a virtual vendor (Block 840). The computing device 110 may allow a user to exchange the coupon for one or more virtual feature 140, either a virtual function or a virtual accessory (Block 850). The computing device 110 may allow the user to barter the virtual feature for other virtual functionalities at the virtual location (Block 860). The computing device 110 may track the user in the virtual environment to best provide future offers (Block 870). Alternatively to the virtual or real coupons, the computing device 110 may provide a virtual experience to the user triggered by the accessory 120, which may automatically transport the user to the virtual location and present a virtual coupon to be exchanged for a virtual feature 140 (Block 880).

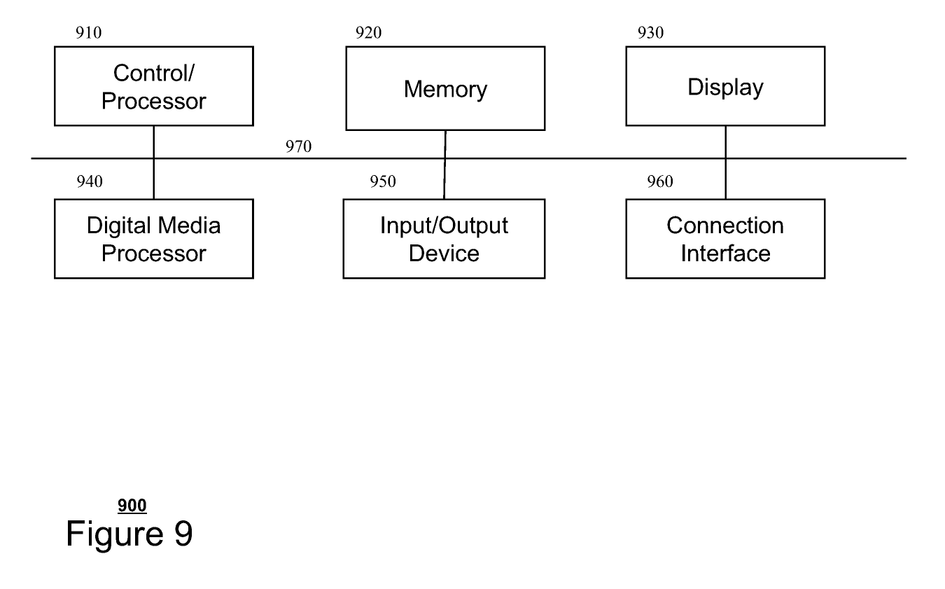

FIG. 9 illustrates a possible configuration of a computing system 900 to act as a mobile telecommunications apparatus or electronic device to execute the present invention. The computer system 900 may include a controller/processor 910, a memory 920, display 930, a digital media processor 940, input/output device interface 950, and a connection interface 960, connected through bus 970. The computer system 900 may implement any operating system, such as Windows or UNIX, for example. Client and server software may be written in any programming language, such as C, C++, Java or Visual Basic, for example.

The controller/processor 910 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 920 may include volatile and nonvolatile data storage, including one or more electrical, magnetic or optical memories such as a random access memory (RAM), cache, hard drive, or other memory device. The memory may have a cache to speed access to specific data. The memory 920 may also be connected to a compact disc-read only memory (CD-ROM, digital video disc-read only memory (DVD-ROM), DVD read write input, tape drive or other removable memory device that allows media content to be directly uploaded into the system.

The digital media processor 940 is a separate processor that may be used by the system to more efficiently present digital media. Such digital media processors may include video cards, audio cards, or other separate processors that enhance the reproduction of digital media. The digital media processor 940 may be used to execute the gaming engine 130.

The Input/Output interface 950 may be connected to one or more input devices that may include a keyboard, mouse, pen-operated touch screen or monitor, voice-recognition device, or any other device that accepts input. The Input/Output interface 950 may also be connected to one or more output devices, such as a monitor, printer, disk drive, speakers, or any other device provided to output data.

The connection interface 960 may be connected to a communication device, modem, network interface card, a transceiver, or any other device capable of transmitting and receiving signals over a network. The network interface 960 may be used to transmit the media content to the selected media presentation device. The network interface may also be used to download the media content from a media source, such as a website or other media sources. The components of the computer system 900 may be connected via an electrical bus 970, for example, or linked wirelessly.

Client software and databases may be accessed by the controller/processor 910 from memory 920, and may include, for example, database applications, word processing applications, the client side of a client/server application such as a billing system, as well as components that embody the decision support functionality of the present invention. The user access data may be stored in either a database accessible through the database interface 940 or in the memory 920. The computer system 900 may implement any operating system, such as Windows or UNIX, for example. Client and server software may be written in any programming language, such as C, C++, Java or Visual Basic, for example.

Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method enhancing functionality in devices, comprising:
pairing a first computing device with an accessory associated with a first virtual feature;
adding the first virtual feature to a first application executed by the first computing device;
storing a virtual feature state associated with the accessory representing the first virtual feature; and
dynamically altering the virtual feature state.

2. The method of claim 1, further comprising:
dynamically altering the virtual feature state as a function of context.

3. The method of claim 1, further comprising:
updating the virtual feature state of the first virtual feature in a virtual feature database.

4. The method of claim 3, wherein the virtual feature database is accessible by a second computing device.

5. The method of claim 3, wherein a second computing device associates with the accessory and accesses the virtual feature state in the virtual feature database.

6. The method of claim 5, wherein the second computing device adds a second virtual feature associated with the accessory and represented by the virtual feature state to a second application.

7. The method of claim 1, further comprising:
updating the virtual feature state of the first virtual feature in the accessory.

8. The method of claim 1, further comprising:
using the virtual feature to access a networked data store.

9. The method of claim 1, further comprising:
detecting the first accessory being out of a given range of the first processing device; and
deactivating the virtual feature.

10. A mobile telecommunications apparatus capable of enhanced functionality, comprising:
a connection interface that pairs a first computing device with a first accessory associated with a first virtual feature;
a memory that stores a virtual feature state associated with the first virtual feature; and
a processor that executes a first application, adds the first virtual feature to the software program, and dynamically alters the virtual feature state as a feature of context.

11. The mobile telecommunications apparatus of claim 10, wherein the connection interface transmits an update of the virtual feature state of the first virtual feature in a virtual feature database.

12. The mobile telecommunications apparatus of claim 11, wherein a second computing device associates with the accessory and accesses the virtual feature state in the virtual feature database.

13. The mobile telecommunications apparatus of claim 12, wherein the second computing device adds a second virtual feature associated with the accessory and represented by the virtual feature state to a second application.

14. The mobile telecommunications apparatus of claim 10, wherein the connection interface transmits an update of the virtual feature state of the first virtual feature in the accessory.

15. The mobile telecommunications apparatus of claim 10, wherein the connection interface detects the first accessory being out of a given range of the first processing device and the processor deactivates the virtual feature.

16. An electronic device capable of enhanced functionality, comprising:
a connection interface that pairs a first computing device with a first accessory associated with a first virtual feature;
a memory that stores a virtual feature state associated with the first virtual feature; and
a processor that executes a first application, adds the first virtual feature to the software program, and dynamically alters the virtual feature state as a feature of context.

17. The electronic device of claim 16, wherein the connection interface transmits an update of the virtual feature state of the first virtual feature in a virtual feature database.

18. The electronic device of claim 17, wherein a second computing device associates with the accessory and accesses the virtual feature state in the virtual feature database.

19. The electronic device of claim 16, wherein the connection interface transmits an update of the virtual feature state of the first virtual feature in the accessory.

20. The electronic device of claim 16, wherein the connection interface detects the first accessory being out of a given range of the first processing device and the processor deactivates the virtual feature.
